(19) United States
(12) Patent Application Publication
(10) Pub. No.: US 2006/0176145 A1
(43) Pub. Date: Aug. 10, 2006

(54) Electronic substrates with thin-film resistors coupled to one or more relatively thick traces

(75) Inventors: Yongki Min, Phoenix, AZ (US); Chien Kuo Yu, Taipei (TW)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/053,636

(22) Filed: Feb. 7, 2005

(51) Int. Cl. H01C 1/012

(52) U.S. Cl. 338/309

(57) ABSTRACT

A substrate that includes an embedded thin-film resistor coupled to one or more relatively thick conductive traces, and its application, are described herein.

### BACKGROUND OF THE INVENTION

1. Field of the Invention

Embodiments of the present invention relate to, but are not limited to, electronic devices and, in particular, to the field of passive components in electronic devices.

2. Description of Related Art

In the current state of electronics, there is a consistent effort to make electronic devices smaller and smaller. This typically means that the electronic components that make up these devices such as microelectronic packages must also become smaller in terms of vertical thickness and horizontal area. These microelectronic packages commonly include a die that is coupled to a supporting substrate called a package or carrier (herein “carrier”) substrate. The packages themselves are then typically mounted onto a printed circuit board (PCB) otherwise known as a “motherboard.”

One approach to making such packages smaller is to embed passive components such as resistors into the die or carrier substrate rather than attaching the discrete passive component on top of the substrate where it can take up valuable real estate. One such embedded resistor is the thin-film resistor, which, as defined for purposes of this description, is a resistor having a thickness of less than or equal to about 1 μm. A resistor having a thickness greater than 1 μm shall be referred to as a non-thin-film or thick-film resistor. In addition to freeing up surface space, these thin-film resistors may have the added advantage of better stability and electrical performance (less overshooting, ringing, and crosstalk).

FIG. 1A depicts a conventional thin-film resistor in a portion of a substrate. The substrate 101 may be an electronic substrate such as a carrier substrate, a printed circuit board (PCB), a printed wire board (PWB) or a multi chip module (MCM). In this illustration, the thin-film resistor 100 is formed on an underlying layer 103 that may include a dielectric such as aminobenzodifuranon (ABF) and/or an organic core. The thin-film resistor 100 is coupled to two conductive interconnects, a first and a second trace 102 and 104. Typically, such a thin-film resistor 100 is formed by forming the traces 102 and 104 first before forming the thin-film resistor 100 on top and between the two traces 102 and 104. On top of the thin-film resistor 100 and the two traces 102 and 104 is a dielectric layer 105. In order to form such a thin-film resistor 100 with thickness of less than or equal to 1 μm using conventional processes, the thickness of the first and/or second traces 102 and 104 cannot be greater than 10 μm (typically for forming conventional thin-film resistor 100, the traces are in the 3-10 μm range). Otherwise there will be poor step coverage (i.e., the resistor film that forms on the sidewall of the traces becomes too thin) as indicated by ref. 106. The poor step coverage may ultimately result in poor resistor performance and stability. Thus, in order to avoid poor step coverage, the thickness of traces 102 and 104 is minimized such as less than 10 μm. The drawback in using traces 102 and 104 having relatively small thickness (e.g., 3-10 μm) is that the operational performance of the traces 102 and 104 may be compromised such as the inability of the traces to accommodate high power delivery.

In order to employ relatively thick traces (greater than 10 μm) with embedded film resistors, one conventional approach is to deposit a thick-film resistor instead of a thin-film resistor between the thick traces. In this approach, the traces are again formed first and a thick-film resistor is formed between the traces by depositing a thick carbon paste onto and between the traces. FIG. 1B depicts a thick film resistor 110 coupled to two thick traces 112 and 114 in a portion of a substrate 111. In this illustration, the thick-film resistor 110 having a thickness of around 20 μm and the thick traces 112 and 114 having thicknesses greater than 10 μm such as 15 μm. Although by using this approach, the thickness of the traces 112 and 114 may be maintained at greater than 10 μm, there are certain drawbacks associated with this approach. For example, by using such a thick-film resistor 110, the overall thickness of the substrate 111 may increase. That is, the thick-film resistor portions 116 (which have a thickness of 20 μm) on top of the traces 112 and 114 result in the dielectric layer 118 being thicker than it would have been had the thick-film resistor portions 116 not been present. In this case, the dielectric layer 118 is thicker by 20 μm (the thickness of the thick-film resistor portions 116) increasing the overall thickness of the substrate 111. In some instances, this means that the dielectric layer 118 having a thickness 119 of 50 μm or greater (the original thickness of the dielectric layer 118 being 30 μm).

### BRIEF DESCRIPTION OF DRAWINGS

The present invention will be described by way of exemplary embodiments, but not limitations, illustrated in the accompanying drawings in which like references denote similar elements, and in which:

FIG. 1A illustrates a portion of a substrate containing a conventional thin-film resistor coupled to traces;

FIG. 1B illustrates a portion of a substrate containing a conventional thick-film resistor coupled to traces;

FIG. 2 illustrates an embedded thin-film resistor coupled to two relatively thick traces in accordance with some embodiments;

FIGS. 3A to 3H illustrate various stages of a process for forming an embedded thin-film resistor coupled to two relatively thick traces in accordance with some embodiments; and

FIG. 4 is a block diagram of an example system in accordance with some embodiments.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention.

The following description includes terms such as on, onto, on top, underneath, underlying, and the like, that are used for descriptive purposes only and are not to be construed as limiting. That is, these terms are terms that are relative only to a point of reference and are not meant to be interpreted as limitations but are, instead included in the following description to facilitate understanding of the various aspects of the invention.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

According to various embodiments of the invention, a substrate containing a thin-film resistor coupled to one or more relatively thick conductive traces (herein “traces”) is provided. For the embodiments, the substrate may be a carrier substrate, a printed circuit board (PCB), a multi chip module (MCM) or other electronic devices that may be embodied in a substrate. Further, the substrate may be a high density interconnect (HDI) and/or low density interconnect (LDI) substrate. The substrate, in some instances, may be an electronic device in the form of a die, a carrier substrate of an electronic package such as a microprocessor, chipset, memory storage, wireless device or package, or a printed circuit board (PCB). For purposes of this description, a thin-film resistor may be defined as a resistor with a thickness of less than or equal to about 1 μm. The one or more traces may have a thickness of greater than 10 μm.

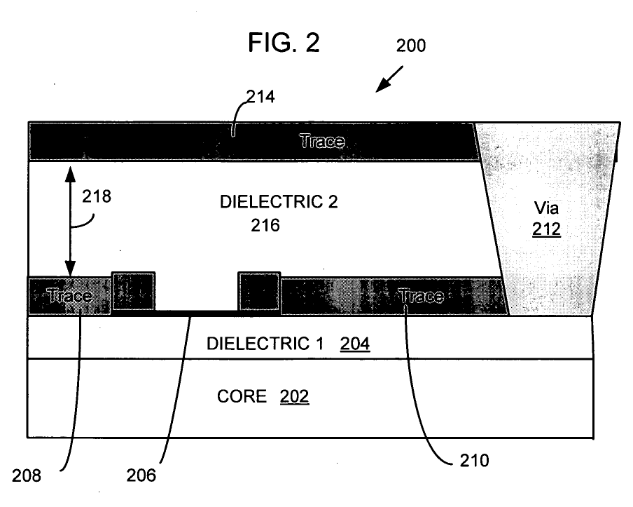

FIG. 2 depicts a first substrate layer of a substrate containing a thin-film resistor coupled to two conductive traces (herein “traces”) in accordance with some embodiments. The substrate 200 may be a carrier substrate, a PCB or other types of electronic substrates. If the substrate 200 is a carrier substrate then the carrier substrate may configured as, for example, flip chip pin grid array (FC-PGA), ball grid array (BGA), land grid array (LGA), or other types of carrier substrates. The substrate 200 may include low density interconnects (LDI) and/or high density interconnects (HDI).

Although not depicted, the substrate 200, in various embodiments, may include multiple substrate layers such as a second, a third, and other additional substrate layers that may be made of various materials such as polymer, ceramic, and various metal layers. The substrate 200 may further include an underlying layer that may include an organic core 202 and/or a first dielectric layer 204. A thin-film resistor 206 that couples first and second trace 208 and 210 may be on top of the first dielectric layer 204. In other embodiments, the thin-film resistor 206 and the first and second traces 208 and 210 may be disposed directly on top of the organic core 202. In yet other embodiments, a thin-film resistor and traces such as those depicted in FIG. 2 may be disposed in a second, third, and/or additional substrate layers of the substrate 200. The second trace 210 may be further coupled to via 212 that is coupled to a third trace 214. Disposed between the first and second traces 208 and 210 and the third trace 214 is a second dielectric layer 216.

The organic core 202 may be made of glass-fiber (silica) reinforced epoxy or other organic or non-organic material that may be used to form the core of, for example, a carrier substrate. The first and second dielectric layers 204 and 216 may be made of a polymer (e.g., epoxy based dielectric material), or other materials suitable for electrically isolating various electronic components.

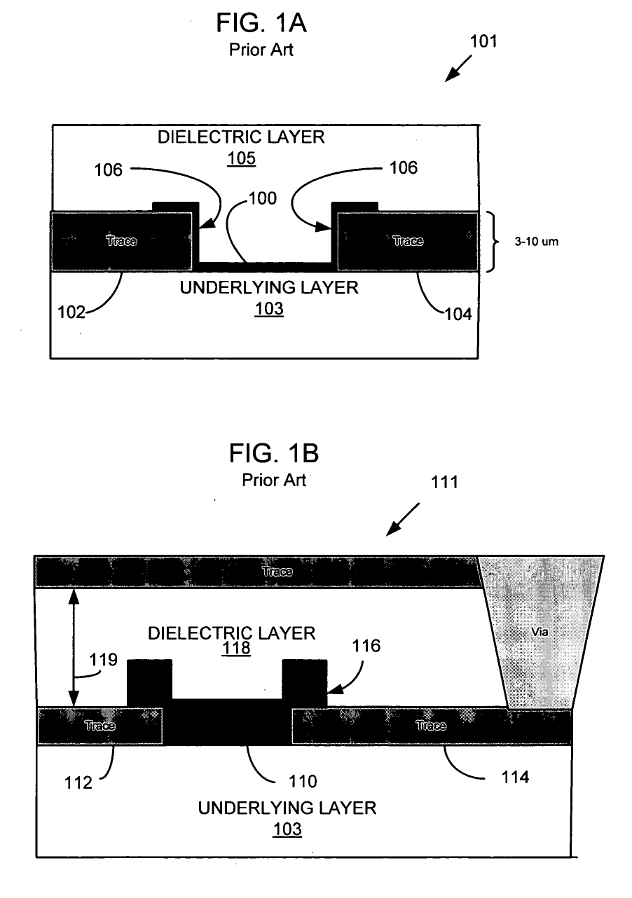

The thin-film resistor 206, in various embodiments, may have a thickness of less than or equal to 1 μm and may be made of various materials such as TaN, NiCr, TaSi, CrNi, NiP, Ni or other resistor materials. Note that unlike the film resistors 100 and 110 of FIGS. 1A and 1B, the thin-film resistor 206 of FIG. 2 does not include a portion that covers the sidewall of the traces 208 and 210. That is, each of the traces 208 and 210 may have a first, a second and a third surface. The first surfaces (e.g., the surfaces facing the first dielectric 204) intersect the second surfaces (e.g., the sidewalls of the traces 208 and 210) while the third surfaces (e.g., the surfaces facing second dielectric layer 216) may be substantially parallel to the first surfaces. In these embodiments, the thin-film resistor 206 may only be coupled to portions of the first surfaces of the traces 208 and 210 and may not be coupled to the second surfaces of the traces 208 and 210. Further, unlike the thick-film resistor 110 of FIG. 1B, thin-film resistor 206 in FIG. 2 does not extend onto the top (i.e., third surfaces) of the traces 208 and 210. As a result, electrical performance of the thin-film resistor 206 is not deteriorated by poor step coverage nor is a thicker dielectric layer 216 (e.g., 50 μm or greater) required that may result in increasing the overall thickness of the substrate 200.

The first and/or second traces 208 and 210 may have a thickness of greater than 10 μm, and in some instances, 15 μm or greater. In various embodiments, the traces 208 and/or 210 may be made of copper (Cu) or some other conductive material. By incorporating relatively thick traces (e.g., traces greater than 10 μm), the traces 208 and 210 may provide better electrical performance and accommodate, for example, high powder delivery.

The first and second dielectric layers 204 and 216 may be made of various dielectric materials such as aminobenzodifuranon (ABF) or other dielectrics. In some embodiments, the second dielectric may have a thickness 218 of less than 50 μm and, in some cases, 20 μm or less. Note that although in FIG. 2, the thin-film resistor 206 is depicted as being on top of a dielectric layer 204, in other embodiments the thin-film resistor 206 may be formed directly on top of the organic core 202.

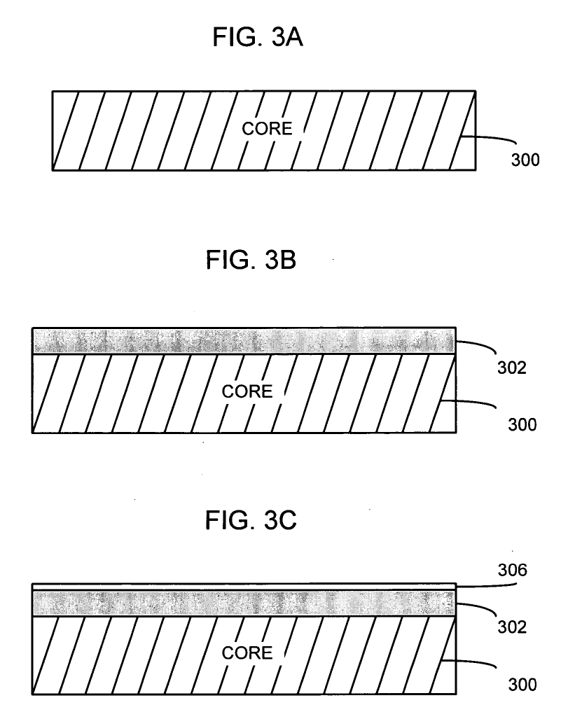

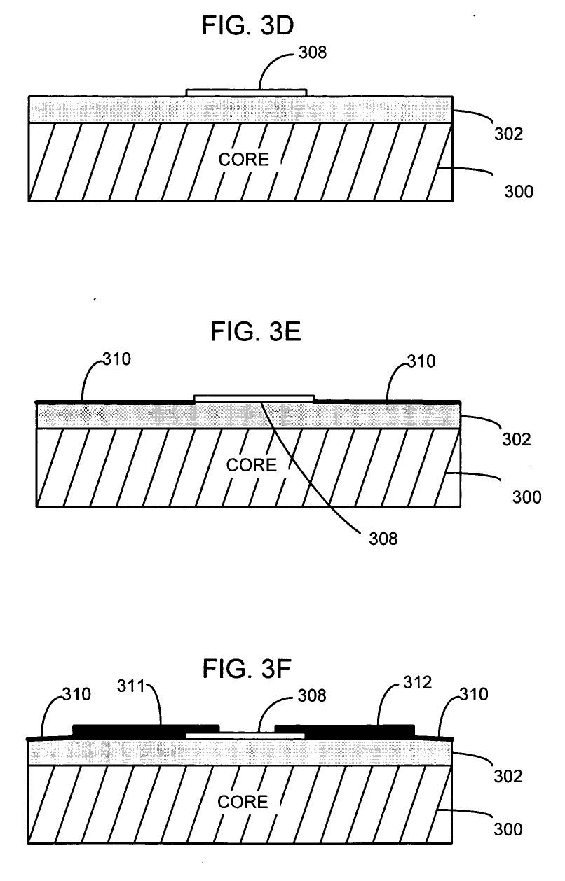

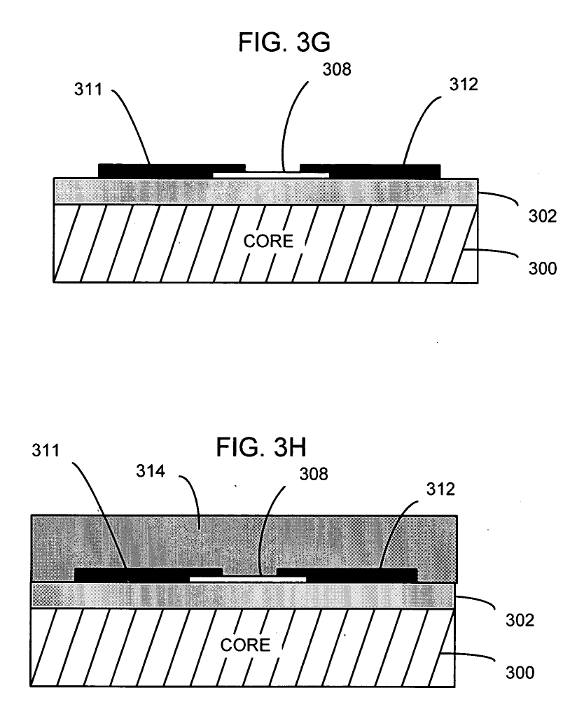

FIGS. 3A to 3H depict various stages for forming a thin-film resistor that may be coupled to one or more relatively thick traces in a substrate in accordance with some embodiments. Initially, a core 300 such as an organic core is provided as depicted in FIG. 3A. A first dielectric layer 302 may be formed on top of the core 300 as depicted in FIG. 3B. The first dielectric layer 302, in some embodiments, may be made of an epoxy based dielectric material such as ABF or some other dielectric material. A thin film 306 of resistor material may then be deposited onto the first dielectric layer 302 using, for example, a plating or physical vapor deposition (PVD) operation that employs, for example, a sputtering technique as depicted in FIG. 3C. If a PVD operation is performed in order to deposit the thin film 306, in various embodiments, the PVD operation may include evaporation and/or ion plating operations. The thin-film resistor material 306 may be made of TaN, NiCr, TaSi, CrNi, NiP, Ni, and/or other resistor material. In various embodiments, the thin-film resistor material 306 may have a thickness of less than or equal to 1 μm.

Once the thin film 306 of resistor material is formed on top of the first dielectric layer 302, the thin-film 306 may be patterned and etched to form a thin-film resistor 308 as depicted in FIG. 3D. The patterning and etching operation may be performed using various techniques. Next, a thin conductive material layer 310 made of, for example, copper (Cu) may be formed or deposited on top of the first dielectric layer 302 as depicted in FIG. 3E. This may be accomplished using, for example, a Desmear operation and electroless Cu (or some other conductive material) plating operation. Next, an image transfer and Cu patterning plating operation may be performed in order to form one or more traces 311 and 312 as depicted in FIG. 3F. An etching operation may be performed in order to remove portions of the thin conductive material 310 that are not covered by the traces 311 and 312 as depicted in FIG. 3G. A dielectric layer 314 may then be formed or laminated on top of the thin-film resistor 308 embedding the thin-film resistor 308 as depicted in FIG. 3H.

In various embodiments, one or more of the above operations may be repeated to form multiple substrate layers containing additional thin-film resistors onto the substrate described above. In addition, other operations such as via opening and filling operations may be performed.

Note that although the operations described above are described in a particular sequential order, in other embodiments, the operations may be performed in a different sequential order. Further, in other embodiments, one or more of the operations may be eliminated from the overall process. Still further, in yet other embodiments, additional operations may be performed.

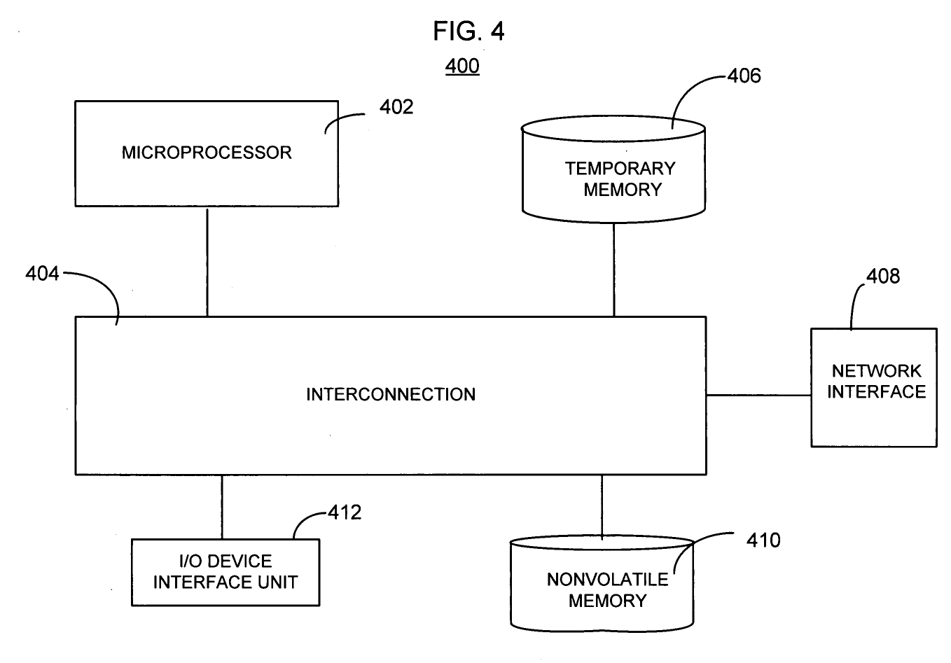

Referring now to FIG. 4, where a system 400 in accordance with some embodiments is shown. The system 400 includes a microprocessor 402 that may be coupled to an interconnection 404, which may include one or more chips. The system 400 may further include temporary memory 406, a network interface 408, an optional nonvolatile memory 410 (such as a mass storage device) and an input/output (I/O) device interface unit 412. One or more of these components may be embodied in an electronic package that may include, for example, a carrier substrate. The interconnection 404, in some instances, may be a bus. In some embodiments, the input/output device interface unit 412 may be adapted to interface a keyboard, a cursor control device, and/or other devices. One or more of the above-enumerated elements, such as microprocessor 402, may include the thin-film resistor/thick conductive trace couplings described above.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the embodiments of the present invention. Therefore, it is manifestly intended that this invention be limited only by the claims.

What is claimed is:

1. A substrate, comprising:
a thin-film resistor, the thin-film resistor having a first and a second end and a thickness less than or equal to about 1 μm; and
a first conductive trace coupled to the first end of the thin-film resistor, the first conductive trace having a thickness of greater than 10 μm.

2. The substrate of claim 1, wherein said thin-film resistor comprises a material having a chemical formula selected from the group consisting of TaN, NiCr, TaSi, CrNi, NiP, and Ni.

3. The substrate of claim 1, wherein the first conductive trace having a thickness of greater than or equal to about 15 μm.

4. The substrate of claim 1, wherein the substrate further comprises a second conductive trace coupled to the second end of the thin-film resistor, the second conductive trace having a thickness of greater than 10 μm.

5. The substrate of claim 1, wherein the substrate further comprises an underlying layer selected from the group consisting of a dielectric layer and an organic core, and wherein the thin-film resistor and the first conductive trace are disposed on top of the underlying layer.

6. The substrate of claim 5, further comprising a dielectric layer disposed on top of the thin-film resistor and the first conductive trace opposite the underlying layer.

7. The substrate of claim 6, wherein the dielectric layer has a thickness less than 50 μm.

8. The substrate of claim 1, wherein the substrate is a carrier substrate.

9. A method, comprising:
providing a substrate;
forming a thin-film resistor on the substrate by a physical vapor deposition (PVD) or plating operation, the thin-film resistor having a first and a second end and a thickness less than or equal to about 1 μm; and
depositing at least a portion of a first conductive trace on the first end of the thin-film resistor, the first conductive trace having a thickness of greater than 10 μm.

10. The method of claim 9, wherein said providing comprises providing a carrier substrate that includes an organic core.

11. The method of claim 9, wherein said forming comprises patterning and etching the thin-film resistor layer to produce the thin-film resistor.

12. The method of claim 9, wherein said PVD operation further comprises an operation selected from the group consisting of sputtering, evaporation, and ion plating.

13. The method of claim 9, wherein said depositing comprises an electroless plating operation.

14. The method of claim 9, wherein said method further comprises forming a dielectric layer on top of the thin-film resistor and the first conductive trace.

15. The method of claim 9, wherein said method further comprises depositing at least a portion of a second conductive trace on the second end of the thin-film resistor.

16. A system, comprising:
a substrate, including:
a thin-film resistor, the thin-film resistor having a first and a second end and a thickness less than or equal to about 1 μm; and
a first conductive trace coupled to the first end of the thin-film resistor, the first conductive trace having a thickness of greater than 10 μm;
an interconnection coupled to the substrate; and
a mass storage coupled to the interconnection.

17. The system of claim 16, wherein the first conductive trace having a thickness of greater than or equal to about 15 μm.

18. The system of claim 16, wherein the substrate further comprises a second conductive trace coupled to the second end of the thin-film resistor, the second conductive trace having a thickness of greater than 10 μm.

19. The system of claim 16, wherein the system further comprises an input/output device interface unit adapted to interface at least a selected one of a keyboard and a cursor control device.

20. The system of claim 16, wherein the system is a selected one of a set-top box, a digital camera, a CD player, a DVD player, a wireless mobile phone, a tablet computing device, or a laptop computing device.

21. A substrate, comprising:
an underlying layer;
a first conductive trace having a first and a second surface, the first surface intersecting the second surface, a first portion of the first surface being coupled to the underlying layer;
a dielectric layer directly coupled to the second surface of the first conductive trace; and
a thin-film resistor with a first and a second end, the thin-film resistor having a thickness less than or equal to about 1 μm, the first end coupled to a second portion of the first surface of the first conductive trace.

22. The substrate of claim 21, wherein the first conductive trace having a thickness of greater than 10 μm

23. The substrate of claim 21, wherein the first conductive trace having a thickness of greater than or equal to about 15 μm.

24. The substrate of claim 21, wherein the substrate further includes a second conductive trace having a first and a second surface, the first surface intersecting the second surface, a first portion of the first surface being coupled to the underlying layer, the dielectric layer directly coupled to the second surface of the second conductive trace, and the second end of the thin-film resistor coupled to a second portion of the first surface of the first conductive trace.

25. The substrate of claim 24, wherein the second conductive trace having a thickness of greater than 10 μm.

26. The substrate of claim 21, wherein the first conductive trace having a third surface, the third surface intersects the second surface and is substantially parallel to the first surface, the third surface directly coupled to the dielectric layer.

27. The substrate of claim 26, wherein the dielectric layer has a thickness less than 50 μm.
